(19) United States
(12) Patent Application Publication
(10) Pub. No.: US 2024/0335255 A1
(43) Pub. Date: Oct. 10, 2024

(54) ENDODONTIC TREATMENT SYSTEM

(71) Applicant: Brand KG, Anroechte (DE)

(72) Inventor: Harald BUCHALLA, Soest (DE)

(73) Assignee: Brand KG, Anroechte (DE)

(21) Appl. No.: 18/743,079

(22) Filed: Jun. 13, 2024

Related U.S. Application Data
(63) Continuation of application No. PCT/DE2022/100945, filed on Dec. 12, 2022.

(30) Foreign Application Priority Data
Dec. 14, 2021 (DE) 10 2021 133 052.1

(51) Int. Cl. A61C 5/44; A61C 1/00; A61C 1/06; A61C 1/08; A61C 5/42

(52) U.S. Cl. CPC A61C 5/44; A61C 1/0061; A61C 1/06; A61C 1/088; A61C 5/42

(57) ABSTRACT

An endodontic treatment system comprising a handpiece and comprising a root canal file that can be detachably coupled to the handpiece. The root canal file has a metallic file wire having a tip, a middle portion adjoining the tip, and a connecting portion adjoining the middle portion. The handpiece has a housing, a drive motor arranged in the housing, and a coupling, which is connected to a drive shaft of the drive motor in a torsionally rigid manner and is rotatably mounted in the housing for transmitting a rotational movement of the drive motor to the file wire.

This nonprovisional application is a continuation of International Application No. PCT/DE2022/100945, which was filed on Dec. 12, 2022, and which claims priority to German Patent Application No. 10 2021 133 052.1, which was filed in Germany on Dec. 14, 2021, and which are both herein incorporated by reference.

### BACKGROUND OF THE INVENTION

### Field of the Invention

The invention relates to an endodontic treatment system comprising a root canal file and a handpiece.

### Description of the Background Art

In dental practice, so-called root canal files 1, also referred to below as “files” for short, are used in the preparation of inflamed dental roots. FIG. 1 indicates such a root canal file 1 known from the prior art. This file 1 comprises a work area 2 and a connecting shaft 3. The work area 2 is made of steel, or in recent times, a nickel-titanium alloy (Ni—Ti). The work area has a drill- or cutter-like structure, and is generally produced by grinding or eroding. The work area 2 is introduced into the root canal. The connecting shaft 3 is connected to a motorized drive 6 via an angular gear (“contra angle”) 5. The unit made up of the contra angle 5 and motorized drive 6 is often referred to as a “handpiece” 8. A handpiece of this type known from the prior art is indicated in FIG. 2.

Files or file wires and their work areas made of Ni—Ti are characterized by extreme flexibility, and at the same time, good torsional strength and better than average resilience against cyclic fatigue.

The connecting shaft 3 at the files is provided nowadays, since for a strictly frictionally engaged coupling or locking of the work area without a connecting shaft in the head 4 of the contra angle, a tensioning device (a collet chuck, for example) present there would have to apply very high tension forces due to the small diameter of the work area or its unprofiled wire end (in the range of 0.8 mm to 1.5 mm). However, this requirement conflicts with the requirement for a head of the contra angle that is as small as possible.

Due to the necessary coupling via a form fit, inserting the files by hand (applying a superimposed rotational movement during the insertion) is complicated and is characterized by unsuccessful attempts. In addition, the geometric dimensions of the shafts must have exact tolerances and therefore must be precisely manufactured.

Furthermore, the necessary forces for opening the tensioning devices in the heads of the contra angles are generally comparatively high. In conjunction with the very small surface areas of the actuating devices, frequent actuation may be very unpleasant or even painful for the fingers (fingertips).

Before beginning the treatment, the anatomy of the tooth to be treated is generally examined by X-ray, and the approximate required length of the work area of the file is determined. This is followed by probing using a specialized file (glide path file) and a measuring device in order to determine the exact distance of allowable penetration of the file into the root canal without advancing beyond the end of the canal (apex) into the surrounding tissue (apex measurement). If this occurs, serious consequences in the treatment may result.

In addition, in various regions of the oral cavity and also as a function of individual circumstances of the treated person (for example, the opening capability of the jaw), any desired amount of space for using files of any given length is not available.

The tensioning of the file or of the file wire that is not possible at the time without a defined connecting shaft (via a frictional connection, for example) prevents adjusting the depth of tension of a file, and thus, adjusting the length of the file segment that emerges from the head (the work area and possibly a piece of lengthening, unprofiled “file wire”).

During the treatment, the file, driven by the motorized drive and coupled via the angular gear, undergoes continuous or oscillating rotational movements.

The present penetration depth of the work area into the root canal is not known to the system made up of the motorized drive and the motor control, and therefore also cannot influence the movement of the file in the root canal. Axial translational movements of the file are generally initiated by the dental practictioner via the movement of the overall handpiece. During the entire treatment, the head of the contra angle, which is large compared to the diameter of the file wire, generally obstructs the visibility of portions of the tooth to be treated, depending on the position of the contra angle. Since the contra angle is situated inside the oral cavity of the patient during the treatment, it must be laboriously cleaned and sterilized after the treatment. This also greatly limits the selection of usable construction materials, as well as the use of a possible electronics system/sensor system in the contra angle.

In order to couple the file to the contra angle via the connecting shaft, the connecting shaft of the root canal file is inserted by hand into the head of the contra angle via superimposed rotational movements. As a result, the locking device that is present there must be opened. This may take place continuously, for example via a folding mechanism, or temporarily, for example via a spring-loaded push button. After the locking device is closed, by use of a lock the connecting shaft of the file at that location is secured from falling out and also coupled in a form-fit manner to transmit torques. As described above, securely connecting the file and the contra angle by hand may be difficult, and in particular may be painful for frequent actuation.

Since the working length L of the work area in the work area boundaries A and B (L=distance A-B; see FIG. 1) of the commercially available root canal files is specified as a set value, it must be fixedly selected from a plurality of available lengths, corresponding to the found physiognomy of the root canal and the accessibility at the location of the treatment. After the apex measurement, the dental practictioner marks the maximum penetration depth into the root canal, generally by means of a stop disc 7 or plastic disc (stopper) that is present on the work area of the file, and a reference point on the tooth to be treated. Besides visual inspection, the dental practictioner has no option for checking the present depth or being warned before penetrating too deeply.

There have been a few attempts, not successful thus far, to superimpose a (small) translational axial movement on the rotational file movement. This was attempted using a mechanically induced “striking movement” in the head. A genuine translational movement with controllable travel, ideally in correlation with the rotational movement prevailing at the time, is not known.

Due to the mechanical requirements of the angular gear and the tensioning device, reducing the size of the head of the contra angle is possible only to a limited extent. The technical limits appear to have been reached here. The contra angle is a high-value asset. A “single-use” approach, which would make the laborious preparation unnecessary, is not economically feasible.

### SUMMARY OF THE INVENTION

It is therefore an object of the invention to provide a compactly designed endodontic treatment system having an axially adjustable work area.

A basic concept of the invention is based on the fact that the mechanical properties of Ni—Ti alloys are settable overall in a wide range, and may be altered locally within a body, via the alloy composition, mechanical processing, and heat treatment. It is thus possible, for example, to design portions of a file wire (of a file) similarly to a spring and with a comparatively high restoring force, and to design other portions to be elastically and/or plastically, and preferably reversibly, deformable as well as “soft” or flexible. Another property is the extremely high cyclic fatigue strength of file wires made of these alloys.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a root canal file from the prior art;

FIG. 2 shows a handpiece for a root canal file from the prior art;

FIGS. 3 to 15 show a root canal file according to the invention; and

FIG. 16 shows a root canal file with a handpiece according to an example of the invention.

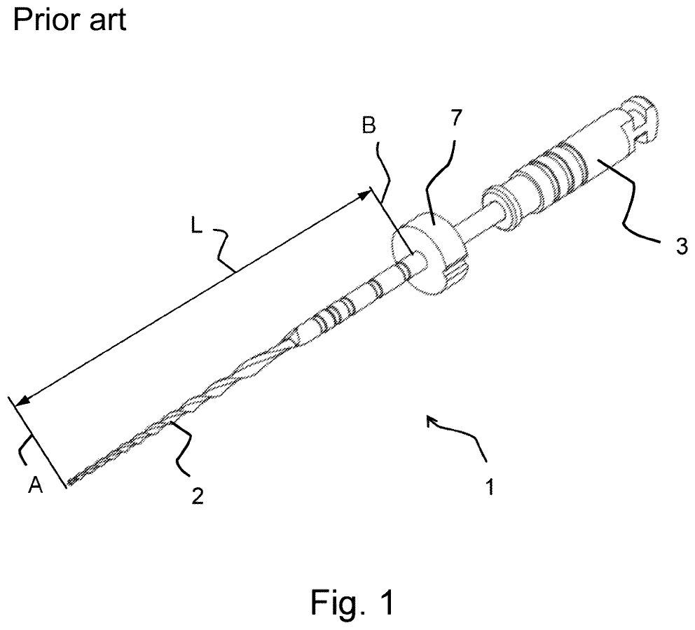

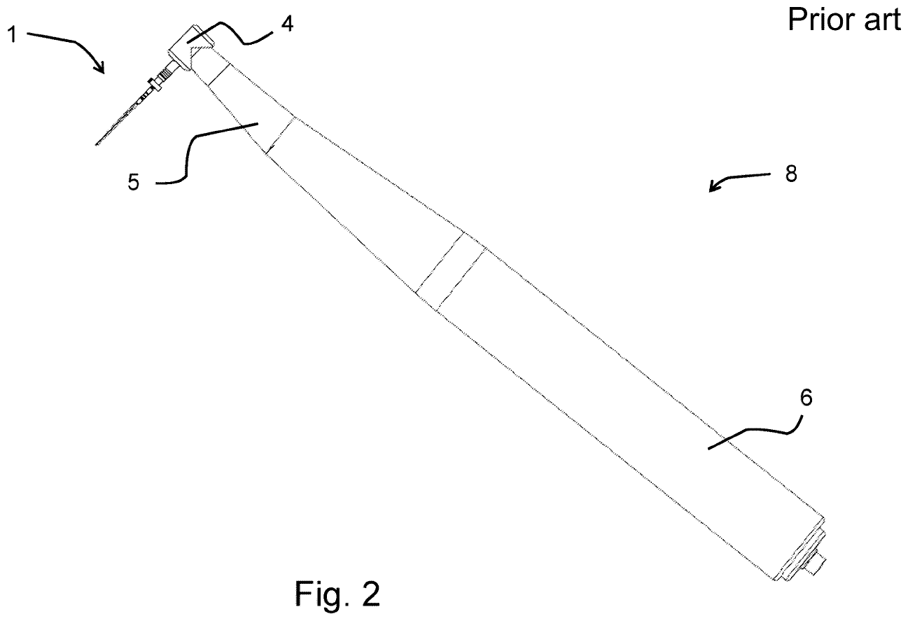

### DETAILED DESCRIPTION

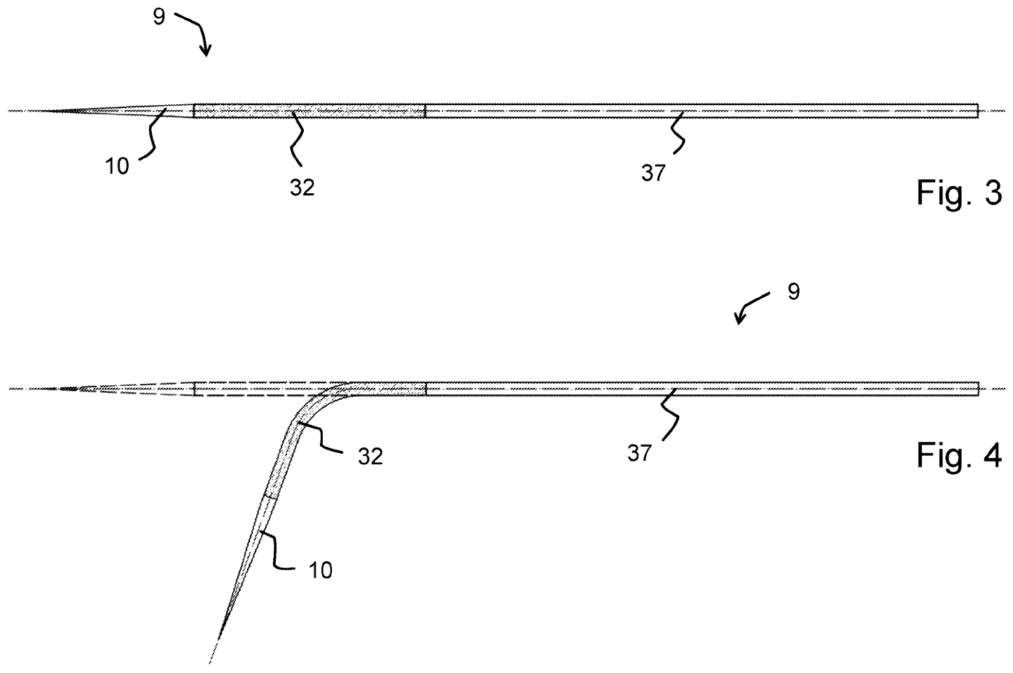

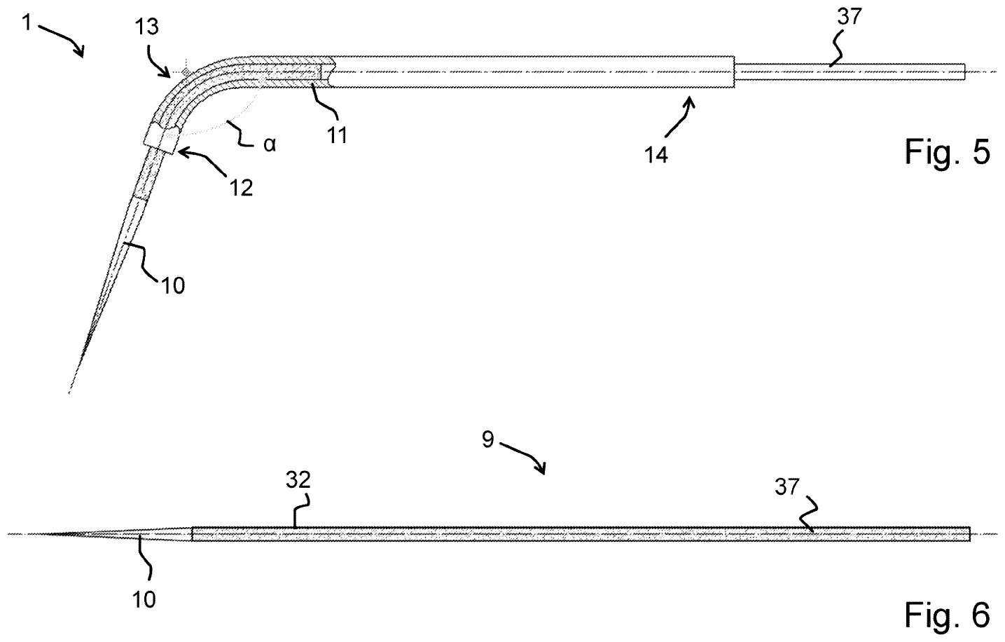

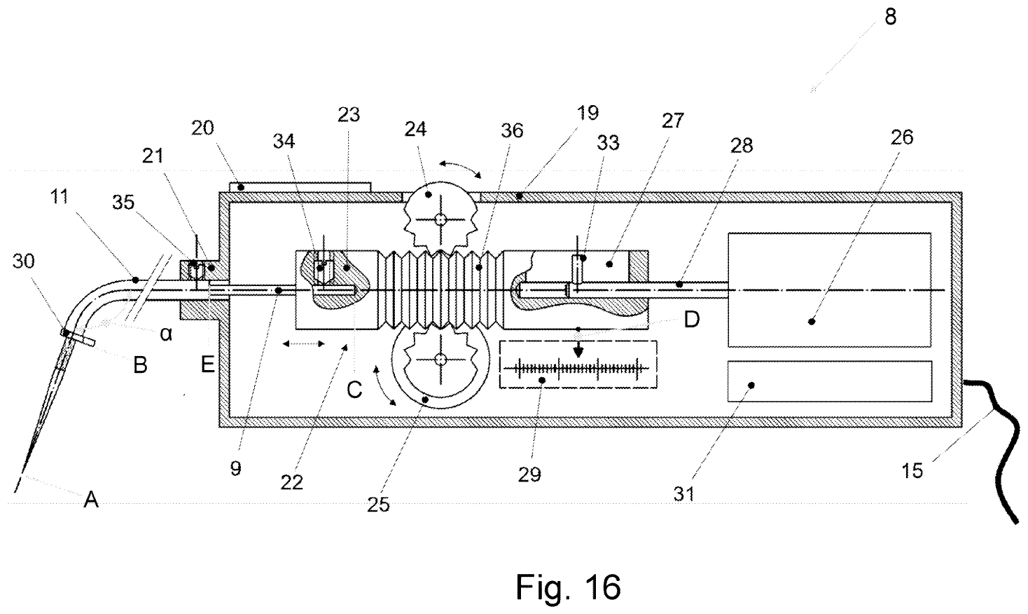

In order to now be able to completely dispense with a “head” and ultimately with a “contra angle,” the conventional work area having the working length L and work area boundaries A, B of the root canal file 1 is greatly lengthened, and the root canal file 1 has no connecting shaft 3, as is apparent in FIGS. 5 and 16. The tip 10 of this root canal file according to the invention or of the file wire, the same as the files that are currently commercially available, are designed (profiled) as a work area 2 according to the particular therapeutic requirements (by grinding, for example), and conditioned by heat treatment, etc., corresponding to the particular requirements. However, the generally unprofiled middle section 32 following the work area is then designed, ideally only by means of heat treatment, in such a way that it is particularly easily deformable, preferably reversibly, with little physical effort, and acquires the highest possible cyclic fatigue strength. The aim is for this region, even in the radially bent shape, to continue to be twistable and axially displaceable as easily as possible, to lose the least possible amount of its torsional strength, and to have high cyclic fatigue strength; see FIGS. 3 and 4.

According to FIG. 5, the endodontic root canal file 1 according to the invention designed in this way is freely movable, axially and rotationally or in the circumferential direction, into a guide tube 11. The tolerances of the inner diameter of the guide tube and of the outer diameter of the file wire 9 of the root canal file according to the invention are to be selected in such a way that optimal radial and axial movability, and at the same time, good radial guiding, are ensured. A radial gap is preferably formed between the guide tube and the file wire. For improving the guiding behavior, the exit end 12 of the guide tube may optionally have a narrower design than, for example, the curved area 13 of the guide tube.

This curved portion of the guide tube is bent in such a way that the work area of the file leaves the exit region of the guide tube at an angle α, preferably in the range of 80° to 130° and particularly preferably 110°±5°, relative to the straight connecting region 14 of the guide tube. The bending of the guide tube may be distributed over multiple sections along a tube length of the guide tube. The file wire of the root canal file according to the invention is then designed in such a way that in any operating state it is ensured that particularly easily deformable zones of the file wire are present also in the curved sections of the guide tube, so that axial displaceability and easy twistability of the file wire in the guide tube are ensured.

According to FIG. 6, the easily deformable zone may also extend over the entire file wire segment after the work area 2, in particular also over the connecting section 37 of the file wire that adjoins the middle section 32.

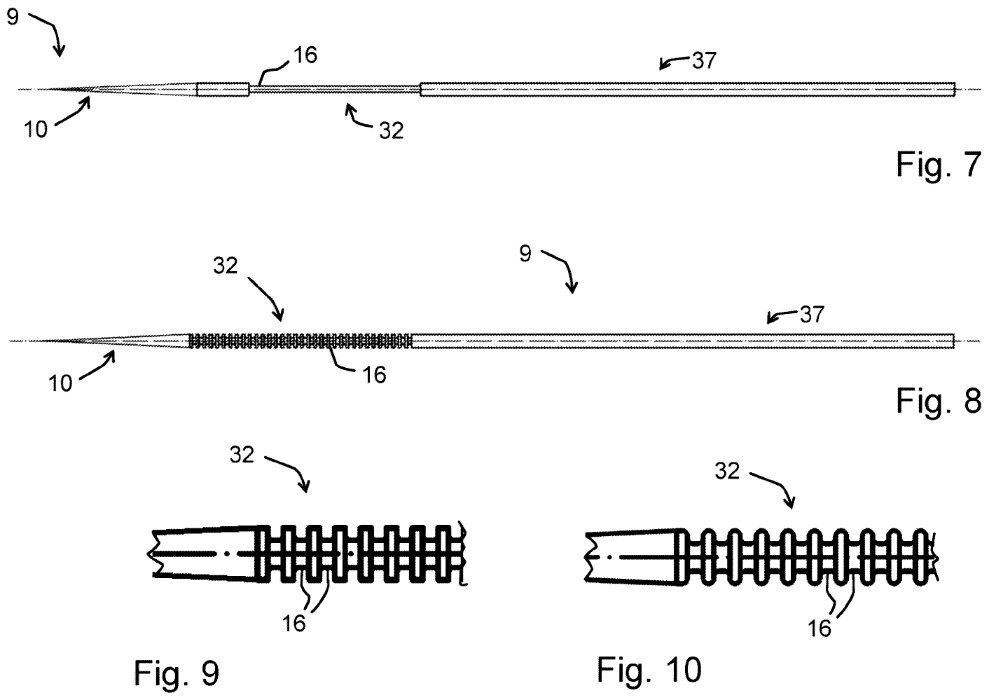

In another form of the root canal file according to the invention, the easily deformable zones of the file wire may also be formed by a structural material weakening. It is conceivable, for example, to reduce the wire diameter or cross section of the file wire at these locations (cross-sectional reduction 16) and thus further improve the bendability of the file wire. Such a cross-sectional reduction in the middle section of the file wire in the form of a notch is shown in FIG. 7.

A similar effect may be achieved when this reduction in the wire diameter occurs only at short intervals, for example via rotationally applied recesses or grooves in the outer diameter according to FIGS. 8 and 9 or according to FIGS. 13 and 14. The guiding of the file wire in the guide tube is thus maintained. The geometry of the cross-sectional reductions is freely selectable within wide limits, and may also have a radially spiral extension, for example. In addition, it may be advantageous to greatly round off the remaining radial ridges at their edges, on the one hand to reduce the friction of the file wire in the guide tube, and on the other hand to further improve the axial displaceability of the file wire in the guide tube. FIG. 10 shows such an embodiment of the file wire with rounded edges of the radial ridges.

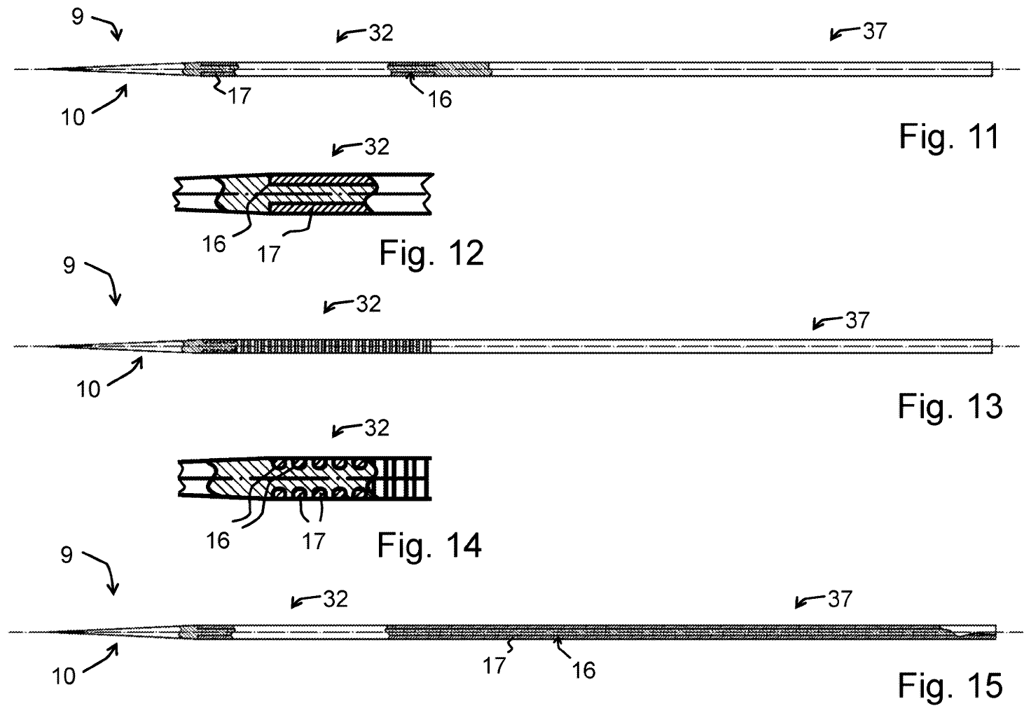

To ensure the guiding and optionally also to improve the gliding behavior, it is likewise conceivable to refill the structurally weakened wire areas with an easily deformable filler material 17, for example an (easy-sliding) plastic, on the former outer diameter of the file wire, for example by extrusion coating (injection molding). Various exemplary embodiments are shown in FIGS. 11 through 15. These measures are naturally also conceivable for the entire region of the file wire after the work area, i.e., besides the middle section 32, also for the connecting section 37 of the file wire, as shown in the exemplary embodiment according to FIG. 15.

Furthermore, it is conceivable to fill the gap between the file wire and the guide tube with a physiologically safe lubricant. With an appropriate selection (via the viscosity, for example), this lubricant may also act as a barrier against possibly biocidal liquids from the treated tooth which rise up in the gap due to capillary action. The indentations in a structurally weakened area, in particular according to FIGS. 8 through 10, are also preferably suitable for this approach.

The file wires according to the invention which are designed in this way, in combination with the guide tubes described above, may then be combined with a handpiece 8, likewise according to the invention.

FIG. 16 shows a schematic diagram of such an arrangement. The handpiece 8 according to the invention is made up of a housing 19 with an interior structure (to be described in greater detail below), a user interface 20, and a supply line 15, provided that the handpiece is not wirelessly connected to an external control unit. The external control unit which may be present is not illustrated. In the simplest case, the control unit is made up of a power supply or a charging unit for the wirelessly operating endodontic treatment system described here.

The root canal file according to the invention may likewise have an internal control unit that is integrated into the housing of the handpiece.

For carrying out the intended function, the guide tube 11 is fixedly coupled to an opening aperture 21 of the housing. This may be achieved by clamping using a clamping screw 35, as schematically illustrated in FIG. 16. In practice, a simpler connection that is ergonomically easier to operate is selected, for example a bayonet connection or a (preferably even automatically actuated) collet chuck. The collet chuck or a suitable device of some other type could be actuated/locked/unlocked via an actuator made of a shape memory alloy, for example. In terms of function, a rigid connection of the guide tube to the housing in the axial direction and the circumferential or radial direction must take place.

The file wire 9 is then likewise radially and axially rigidly coupled to the radially and axially movable coupling 22. This coupling 23, as described above, may likewise be achieved by clamping via a clamping screw 34, as schematically illustrated in FIG. 16. However, since this coupling is situated inside the housing of the handpiece according to the invention, a simpler connection that is ergonomically easier to operate is preferably selected. Due to the available installation space here, a frictionally engaged connection such as an (automatically actuated) collet chuck, for example, is also conceivable. The collet chuck or a suitable device of some other type could be actuated/locked/unlocked via an actuator made of a shape memory alloy, for example.

The radially and axially movable coupling 22 may be axially moved, selectively or in a combined manner via the mechanical manual adjustment 24 and/or by actuator via the servomotor 25. Manual actuation is likewise conceivable using an appropriate command to the servomotor via the user interface. The mechanical manual adjustment may then be dispensed with. For this purpose, the coupling may have external teeth 36, for example, in which a gearwheel that is rotatable via the manual adjustment 24 or the servomotor 25 engages. The gearwheel associated with the manual adjustment is preferably accessible from a housing opening 38 in the housing of the handpiece for manual adjustment.

Appropriate commands may also come from an external control unit. In all cases, it is conceivable for the present selected length to be represented at the user interface of the handpiece and/or optionally of the external control unit. This is possible due to the fact that the present working length L of the work area having the work area boundaries A, B of the root canal file 1 is known at all times.

By use of this arrangement, it is now possible to adjust to a great extent the active working length L of the work area having the work area boundaries A, B (and thus adapt to the requirements for treatment), and also to superimpose practically any desired axial movement on the rotational movement of the file wire. In one particularly advantageous form, rotational and axial movements are combined with one another in such a way that a treatment process according to the invention, not achievable thus far with regard to efficiency and effectiveness, results. Thus, as an example it is conceivable to superimpose a (small) forward movement in the direction of the apex on the “removing” rotational movement of the file wire, thus enabling a finely controllable forward feed. For a “releasing” countermovement of the root canal file, an opposite (larger) stroke could then be analogously superimposed to ensure optimal transport of the removed substance.

A closing stop 30 that is flush with the exit end 12 is provided at the guide tube 11. The stop 30 is preferably designed as a stop disc that is eccentrically shaped in relation to a wire axis of the file wire 9 and held in a radially movable manner. In addition, the torque and/or the in particular axially acting forces may be determined in the region of the stop 12 or at the exit end 12 of the guide tube 11. In this way, the forces or torques acting on the work area 12 of the file wire 9 may be determined, and file breakage may be prevented.

The rotational movement of the file wire is induced by the drive motor 26 via the coupling 22. The drive motor, via its drive shaft 28, is connected in the coupling (coupling 27) via a bolt 33 radially situated perpendicular to the drive shaft as schematically shown in FIG. 16, preferably rigidly in the radial direction but movably in the axial direction. An axial movement may thus be superimposed on the rotational movement of the file wire without the drive motor itself also having to be moved along its axis 18. FIG. 16 shows (only) one schematic form of such a type of coupling.

Also situated in the handpiece is a distance measuring system 29 that is able to measure the axial movement of the coupling, and thus, when the root canal file is coupled as described above, to measure the axial position of the file wire and the working length L of the work area, having the work area boundaries A, B, that leaves the exit end of the guide tube 11 in relation to the handpiece 8. If the root canal file 1 is clamped in the coupling (coupling 23) in a defined manner, for example up to a coupling stop (position C), the distance A-C (file tip (position A) to the coupling stop (position C) at the guide tube 11 in the coupling) is known via the overall physical length of the file wire 9. The same applies for the length and position of the guide tube 11 (distance B-E). Via the measured axial position D of the coupling and the known geometries inside the handpiece, it is then possible to compute in a defined manner the working length L of the work area, having the work area boundaries A, B, of the root canal file 1.

The electrotechnical or electronic components, for example a chargeable electrical energy store, a pressure sensor and/or torque sensor, the distance measuring system, the servomotor, the drive motor, a conveying device for a fluid, a light source, and the user interface, are preferably operatively connected to the internal control unit of the handpiece 8 that is integrated into the housing 19, or to an external control unit (electronic unit 31) via the supply line. It is likewise conceivable to design the control unit and the user interface, for example, as a single part while maintaining the concept of the invention.

The invention is not limited to the described embodiments of the root canal file 1 and/or of the handpiece 8. The components are freely selectable within wide limits with regard to their shape, material, proportions, and configuration relative to one another.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An endodontic treatment system comprising:
a handpiece; and
a root canal file that is detachably coupleable to the handpiece, the root canal file having a metallic file wire with a tip, a middle section adjoining the tip, and a connecting section adjoining the middle section, the handpiece having a housing, a drive motor arranged in the housing, and a coupling, which is connected to a drive shaft of the drive motor in a torsionally rigid manner and rotatably supported in the housing for transmitting a rotational movement of the drive motor to the file wire,
wherein the coupling is supported in the housing so that it is axially adjustable by hand and/or an actuator, such that a working length of a work area of the root canal file,
with which a free end of the tip of the file wire protrudes from the guide tube, is adjustable.

2. The endodontic treatment system according to claim 1, wherein the file wire is deformable in the region of the middle section, and is designed with high torsional rigidity and high fatigue strength.

3. The endodontic treatment system according to claim 1, wherein the root canal file has a curved guide tube in which the file wire is radially and axially movably guided in the region of the middle section, wherein the guide tube is clamped in an opening aperture of the housing, and wherein the connecting section of the file wire is releasably clamped in the coupling in a radially and axially rigid manner.

4. The endodontic treatment system according to claim 1, wherein the file wire is manufactured in one piece and is made of a corrosion-resistant metal, preferably made of a shape memory alloy, and particularly preferably made of a nickel-titanium alloy.

5. The endodontic treatment system according to claim 1, wherein the file wire is manufactured in multiple pieces, the middle section of the file wire being made of a material that is softer than the tip and/or the connecting section of the file wire.

6. The endodontic treatment system according to claim 1, wherein the file wire has at least one or only one cross-sectional reduction in the region of the middle section.

7. The endodontic treatment system according to claim 6, wherein the cross-sectional reduction of the file wire is filled with a deformable, slidable filler material, and is extrusion-coated with a thermoplastic and/or elastomeric plastic.

8. The endodontic treatment system according to claim 1, wherein a gap that is formed between the guide tube and the file wire is filled with a liquid and/or viscous lubricant.

9. The endodontic treatment system according to claim 1, wherein in an exit end facing the tip of the file wire, the guide tube has a reduced tube outer diameter, which is applied all the way around the file wire.

10. The endodontic treatment system according to claim 1, wherein a stop that terminates in flush abutment with the exit end, and a stop disc that is eccentrically shaped in relation to a wire axis of the file wire and held in a radially movable manner, are mounted on the guide tube.

11. The endodontic treatment system according to claim 1, wherein a clamping screw and/or a bayonet lock and/or a spring-loaded and/or actuator-actuatable clamping device are provided for clamping the file wire to the coupling and/or clamping the guide tube to the housing of the handpiece.

12. The endodontic treatment system according to claim 1, wherein the coupling has external teeth, and also arranged in the housing is a gearwheel which engages in the external teeth and is driven by actuator by a servomotor arranged in the housing, and/or a gearwheel that is accessible through a housing opening of the housing and manually adjustable, in such a way that the coupling is axially adjustable by rotating the gearwheel.

13. The endodontic treatment system according to claim 1, wherein an electric distance measuring system is arranged in the housing of the handpiece, the distance measuring system being designed to determine an axial displacement of the coupling.

14. The endodontic treatment system according to claim 1, wherein the handpiece has a chargeable electrical energy store situated in the housing and is wirelessly operable.

15. The endodontic treatment system according to claim 1, wherein a sensor and a pressure sensor are associated with the stop such that contact of the stop with a tooth to be treated is detectable.

16. The endodontic treatment system according to claim 1, wherein via a rinsing line that is mounted on the guide tube and extends in parallel thereto, and/or via the gap that is formed between the guide tube and the file wire, a fluid is suppliable and/or suctionable via a conveying device connected thereto.

17. The endodontic treatment system according to claim 1, wherein the guide tube has a light-guiding design, and/or a light guide extending in parallel to the guide tube is mounted thereon, and a light source in operative connection with the light guide and/or the guide tube is arranged in the housing of the handpiece.

18. The endodontic treatment system according to claim 1, wherein the handpiece has a user interface that is mounted on the outer side of the housing and operatively connected to an internal control unit and/or external control unit that is in operative connection with the electrical components of the handpiece, the user interface having a display and/or control elements for inputting control commands, and/or acoustic and/or optical and/or haptic signal generators.

19. The endodontic treatment system according to claim 1, wherein a value measured by the distance measuring system is output, and/or the axial adjustment of the coupling by the actuator is set in a defined manner, via the user interface.

20. The endodontic treatment system according to claim 1, further comprising a torque transducer and/or force transducer arranged in the housing of the handpiece and/or in the coupling and/or in the guide tube in a region of the exit end, the torque transducer and/or force transducer being intended for determining torques and/or forces acting on the file wire.
